(19) United States
(12) Patent Application Publication
(10) Pub. No.: US 2021/0120783 A1
(43) Pub. Date: Apr. 29, 2021

(54) TWO-HANDED RETRACTABLE DOG LEASH

(71) Applicant: Puppy Products, Inc., Leesburg, FL (US)

(72) Inventors: James Bowden, Leesburg, FL (US); Lisa Fitzgerald, Leesburg, FL (US)

(21) Appl. No.: 17/073,894

(22) Filed: Oct. 19, 2020

Related U.S. Application Data
(60) Provisional application No. 62/925,346, filed on Oct. 24, 2019.

(51) Int. Cl. A01K 27/00; B65H 75/40; B65H 75/30

(52) U.S. Cl. CPC A01K 27/004; B65H 75/30; B65H 75/406

(57) ABSTRACT

A two-handed retractable dog leash that provides two gripping handles integrated into a retractable leash. This eliminates problems handling large, strong and aggressive dogs by using the strength of both of the user's arms. The length of the handle allows enhanced control of the lease position to avoid becoming wrapped, by the dog, with the leash.

### TECHNICAL FIELD

The present invention relates generally to the field of animal leashes, and more particularly, to retractable dog leashes having a plurality of handles to better control the dog while using the leash(es).

### BACKGROUND

Dogs kept as domestic pets inside the home need to be walked by their owner at least twice a day to relieve themselves of bodily waste and to further provide sufficient exercise. A leash is used to restrain the dog from running away and to prevent contact with people, other animals, and property outside of the home. In many communities, rules prohibit dogs from freely roaming about—often requiring dogs to be leashed at all times. Dogs come in many sizes, based on breed, that can typically range from 1 to 150 pounds. In many cases, the dog walker does not have the strength to control a large or strong dog with one hand grasping a leash. In this case the walker can be pulled to an off-balanced position causing an injury by falling. Even a small dog has the ability to wrap the walker's legs with the leash, causing trip and fall injuries.

Over the past several decades, retractable leashes have become commercially available and are frequently used to walk dogs. The retractable feature allows the leash to be dispensed to a length desired by the walker and then retracted as required to control the dog's range of freedom. In the case of the retractable leash, these leashes typically are comprised of a leash, a spring-loaded retractable leash mechanism, and a hand grip. This type of leash lacks the ability to easily control large or strong dogs and relative leash position. Although retractable leashes alleviate some of the above mentioned problems observed with conventional leashes, many problems still exist with conventional retractable and non-retractable leashes.

Therefore, a need exists to provide a better leash that allows the dog walker to better control the dog, and further disclosed herein is a two-handed retractable leash that allows the walker to grip the leash with both hands, thereby allowing more body strength to control the dog. The increased length of the two-handed retractable leash allows the walker to have better directional control, thereby not becoming tangled or wrapped in the leash.

### SUMMARY

Thus disclosed is a two-handed retractable dog leash that incorporates a fabric woven leash, a swivel connector, a constant force spring biasing a retraction spool, a means to lock the spool with a hand-operated stop and a plastic enclosure. The plastic enclosure contains an integral hand grip proximal to the retraction mechanism and a distal hand grip. The retraction mechanism consists of a spool constrained and allowed to spin freely on axles as part of the plastic enclosure.

The leash is permanently connected and wrapped around the spool, and is routed through a track, as an integral part of the enclosure, and connected to a swivel-type clasp on the outside of the enclosure. This swivel prevents leash twisting and binding inside the retraction mechanism. Rollers at the point where the leash exits the enclosure provides a low friction and low wear rubbing surface. As the leash is pulled away from the retraction mechanism, a constant force spring, as an integral part of the spool, is wound to provide a radial spring bias to the spool. When the leash is released, this spring bias rewinds the leash back onto the spool. The retraction mechanism is locked by means of a push-push type locking plunger that, in the distal position, is clear from contact with the spool. In the proximal position, the plunger, by means of appendages as part of the plunger, interferes with a plurality of teeth located around the circumference of the retraction spool, thus locking the spool from any radial motion. This restricts the dog's range of freedom. In certain aspects, the two-handed retractable dog leash includes a drag assembly positioned internally within the retractable dog least that is configured to selectively reduce and/or limit leash movement and feed speed through the opening positioned on the second end of the elongate handle. The drag assembly includes a slip type tooth on the spool and a spring-loaded retainer pawl allows the spool to rotate and dispense additional leash if the leash is pulled with extreme force. This is a safety function to minimize the initial inertial load of a running dog at the end of its leash. Drag on the leash (similar to drag on a fishing reel), is obtained using this mechanism. This prevents injury by limiting the pull force of the dog on the user. The distal and proximal hand grips, as an integral part of the enclosure, allow the user to use the strength of both arms to control the dog. The extra length of the device, inherent to the design, allows the user to have enhanced directional control of the leash. Also, the device has an aperture as part of the enclosure to snap on accessories such as a key ring. For example, in certain aspects disclosed is a two-handled retractable dog leash adapted for gripping with two hands that includes (a) an elongate housing comprising (i) a first end terminating in a first handle integrally formed on the elongate housing and configured for gripping the dog leash, (ii) a second end spaced apart from the first end of the elongate housing, the second end configured to feed and retract a dog leash through an opening positioned thereon, and (iii) a second handle integrally formed on the elongate housing positioned between the first and second spaced apart ends of the elongate housing, the second handle configured for being gripped concurrently with the first handle to maintain control of a dog; (b) a rotatable, retractable spool positioned inside the elongate housing proximate to the first handle; and (c) a retractable leash wrapped around and carried on the spool, the retractable leash configured to selectively adjust in length through the opening positioned on the second end the elongate handle. In certain aspects, the two-handled retractable dog leash further includes an axle internally positioned axle that carries the rotatable, retractable spool thereon. In certain aspects, the two-handled retractable dog leash further includes a locking mechanism in operable contact with the rotatable, retractable spool configured to lock the spool thereby preventing length adjustment of the leash. In certain aspects, the two-handled retractable dog leash further includes a plurality of spaced apart fasteners positioned along the length of the elongate housing configured to secure and maintain the elongate housing as a unitary component. In certain aspects, the elongate housing comprises a rigid or a semi-rigid material. In certain aspects, the rigid or semi-rigid material is a moldable thermoplastic resin or a millable resin. In certain aspects, the two-handed retractable dog leash includes a drag assembly positioned internally within the retractable dog least that is configured to selectively reduce and/or limit leash movement and feed speed through the opening positioned on the second end of the elongate handle. In certain aspects, the drag assembly includes a lever that is externally positioned on the first handle of the two-handled retractable dog leash and is operatively connected to the drag assembly such that drag assembly reduces and/or limits leash movement through the opening positioned on the second end of the elongate handle when the drag assembly lever is actuated. The drag assembly may be unidirectionally operable (operational in one direction) to selectively reduce and/or limit leash movement and feed speed one way when the leash is fed through the opening positioned on the second end of the elongate handle to extend length of the leash outside of the housing of the two-handled retractable dog leash but does not selectively reduce and/or limit leash movement when retracting the leash through the second end of the elongate handle and rewinding the leash onto the spool. In certain aspects, the drag assembly lever is positioned on an underside of the first handle of the two-handled retractable dog leash. In certain aspects, the drag assembly lever is positioned on an underside of the first handle of the two-handled retractable dog leash.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is an Isometric view of the two-handed retractable dog leash;

FIG. 2 is a Left view of the two-handed retractable dog leash;

FIG. 3 is a Bottom view of the two-handed retractable dog leash;

FIG. 4 is a Front view of the two-handed retractable dog leash;

FIG. 5 is a Back view of the two-handed retractable dog leash;

FIG. 6 is a Right view of the two-handed retractable dog leash;

FIG. 7 is a Top view of the two-handed retractable dog leash;

FIG. 8 is another Left view of the two-handed retractable dog leash;

FIG. 9 is a Section view of FIG. 8;

FIG. 10 is another Section view of FIG. 8

FIG. 11 is a Right view with the right housing removed;

FIG. 12 is a Left view with the left housing removed;

FIG. 13 is another Bottom view of the two-handed retractable dog leash;

FIG. 14 is a Section view of FIG. 13;

FIG. 15 is an Exploded view of the two-handed retractable dog leash;

FIG. 16 is a Detail view of FIG. 15;

FIG. 17 is an Isometric view of the two-handed retractable dog leash;

FIG. 18 is a Left view of the two-handed retractable dog leash;

FIG. 19 is a Bottom view of the two-handed retractable dog leash;

FIG. 20 is a Front view of the two-handed retractable dog leash;

FIG. 21 is a Back view of the two-handed retractable dog leash;

FIG. 22 is a Right view of the two-handed retractable dog leash;

FIG. 23 is a Top view of the two-handed retractable dog leash;

FIG. 24 is another Left view of the two-handed retractable dog leash;

FIG. 25 is a Section view of FIG. 24;

FIG. 26 is another Section view of FIG. 24;

FIG. 27 is a Right view with the right housing removed;

FIG. 28 is another Right view with the right housing removed;

FIG. 29 is an Exploded view of the two-handed retractable dog leash; and

FIG. 30 is a Front view of the drag spool included within the two-handed retractable dog leash.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be thorough and complete, and will fully convey the scope of the invention and enable one of ordinary skill in the art to make, use and practice the invention. Like reference numbers refer to like elements throughout the various drawings.

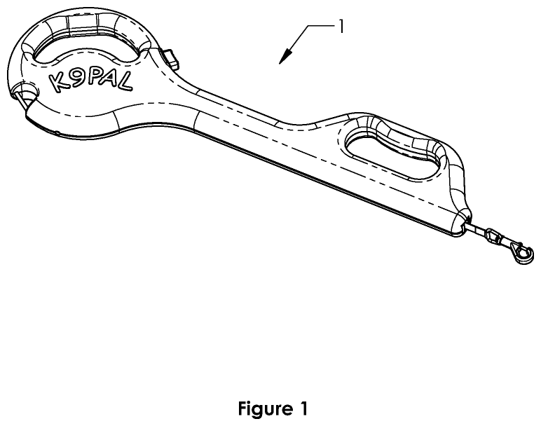

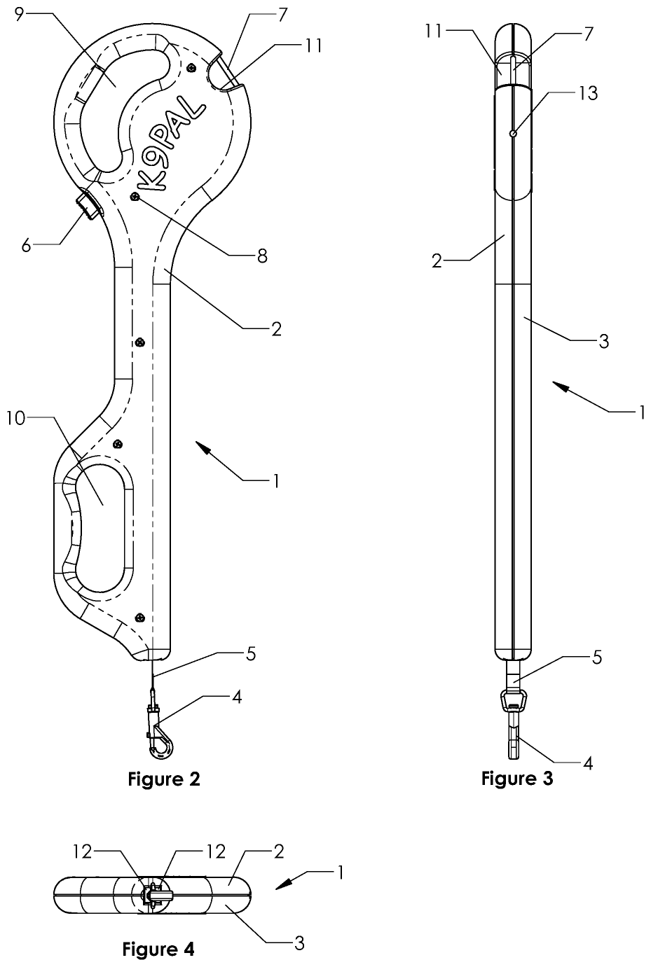

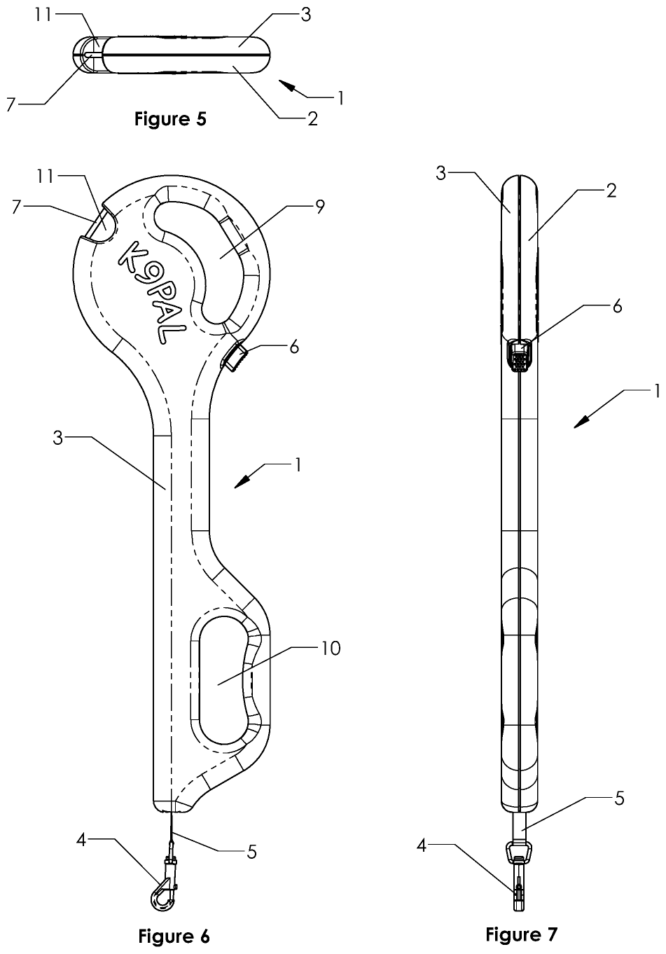

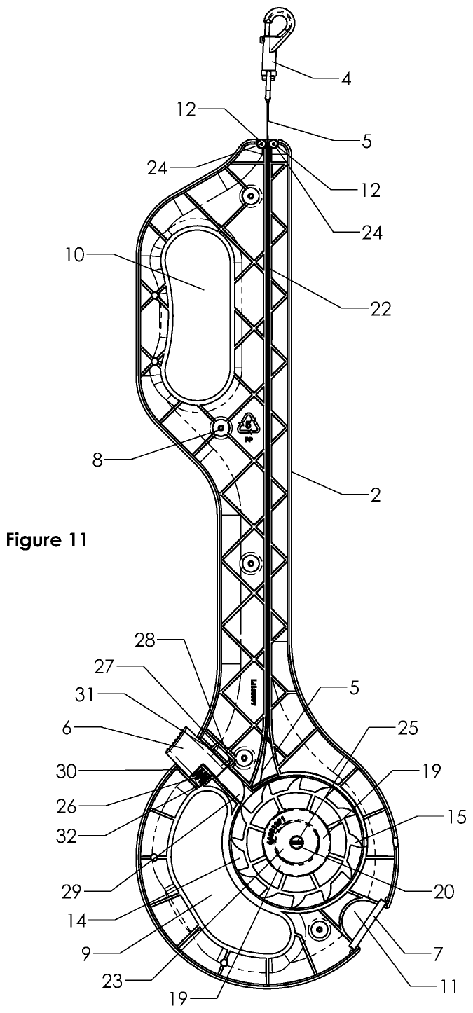

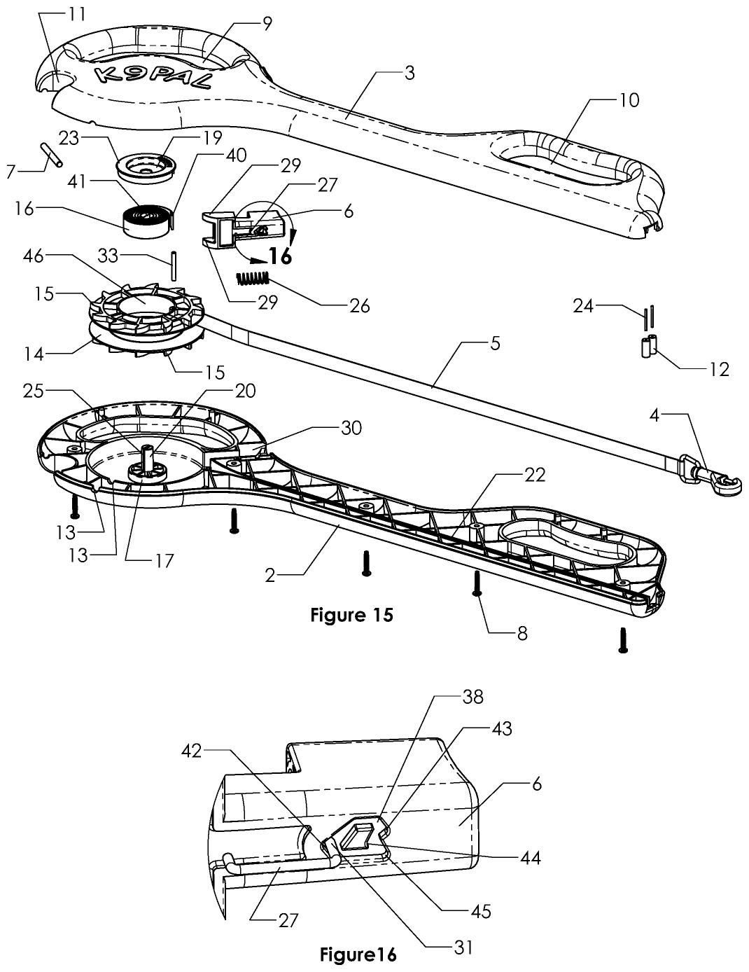

Referring to FIGS. 1, 2, 3, 4, 5, 6, 7 and 15, the two-handed retractable dog leash 1 consists of left housing 2, right housing 3, swivel clip 4, leash strap 5, stop actuator 6 and accessory clip bar 7. The left housing 2 and right housing 3 are held together by a plurality of screws 8. The left housing 2 and right housing 3 assembled form rear grip 9, forward grip 10 and accessory clip aperture 11. Referring to FIGS. 9 and 11, the left housing 2 and right housing 3 assembled also captures spool 14, stop actuator keeper 27, two rollers 12, roller pins 24, lease 5, clip bar 7 and stop actuator 6. Drain hole 13, an integral part of left housing 2 and right housing 3, allows moisture, typically from a wet leash, to drain from the internal volume.

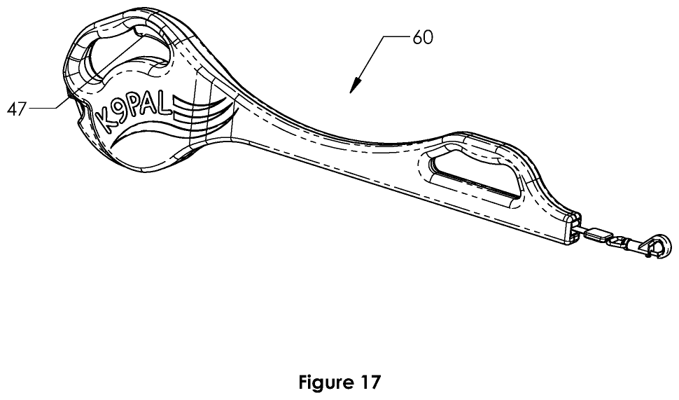

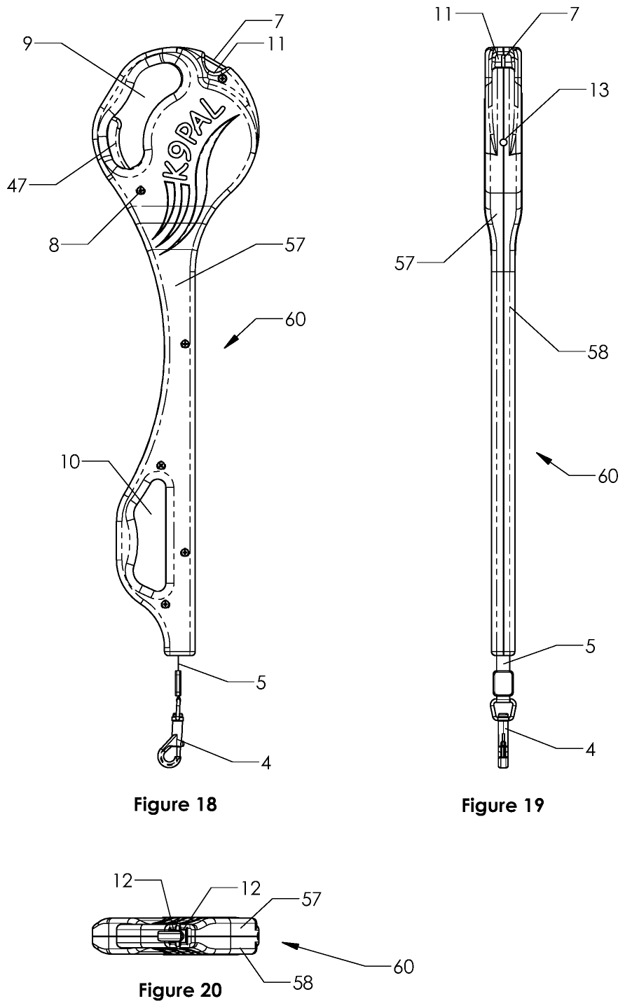

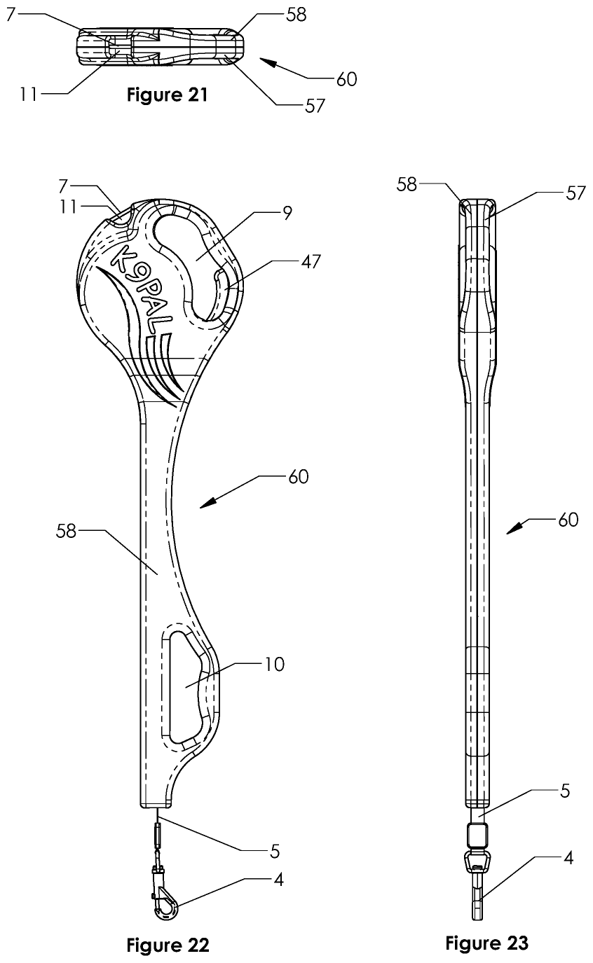

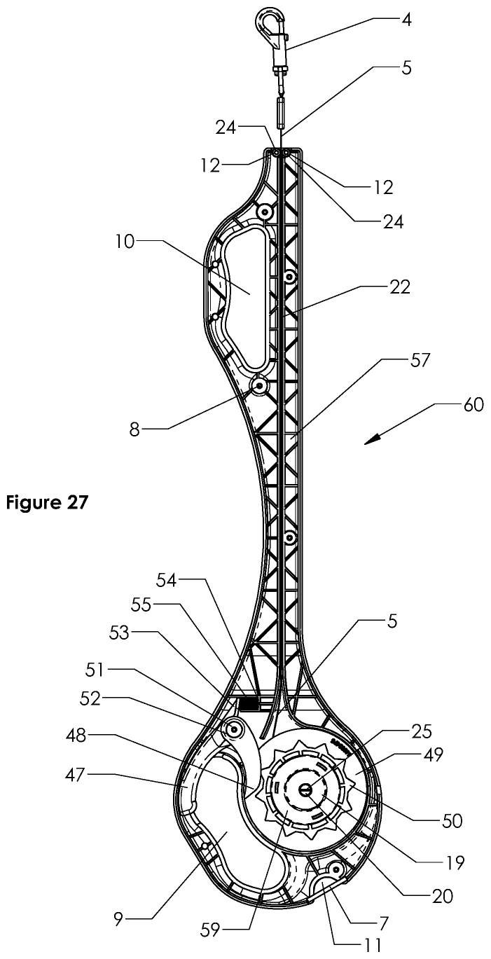

Referring to FIGS. 17, 18, 19, 20, 21, 22, 23, 27, and 28, another embodiment of the two-handed retractable dog leash assembly with drag lever 60 consists of left drag housing 57, right drag housing 58, swivel clip 4, leash strap 5, leash release lever 47 and accessory clip bar 7. The left housing 57 and right housing 58 are held together by a plurality of screws 8. The left drag housing 57 and right drag housing 58 assembled from rear grip 9, forward grip 10 and accessory clip aperture 11. Referring to FIGS. 25 and 27, the left housing 57 and right housing 58 assembled also captures drag spool 49, leash release lever 47, two rollers 12, roller pins 24, lease 5, clip bar 7. Drain hole 13, an integral part of left drag housing 57 and right drag housing 58, allows moisture, typically from a wet leash, to drain from the internal volume.

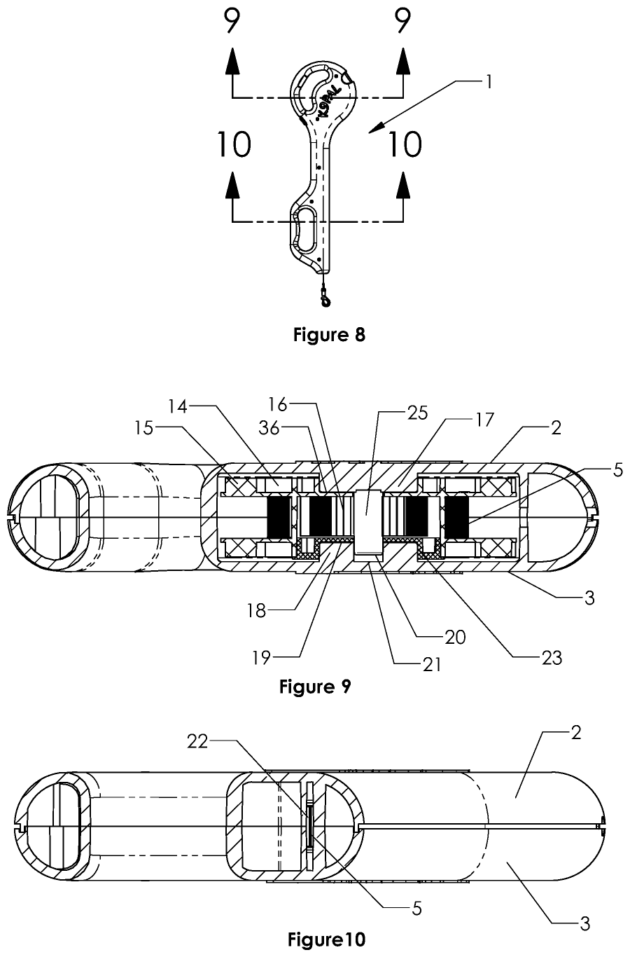

Referring to FIGS. 8, 9, 10, 11, 12 and 15, in the two-handed retractable dog leash 1, the leash retraction mechanism consists of the spool 14, constant force spring 16, spool cover 23, stop actuator 6, stop actuator spring 26 and stop actuator keeper 27. The spool 14 is biased in the fully leash 5 retracted position by the constant force spring 16. As leash 5 is pulled by the swivel clip 4 in a distal direction, the constant force spring 16 is wound to bias the spool 14 in the opposite rotation to provide spring energy to rewind. This spring is constrained in spring cavity 46 on spool 14 by means of spring hook 40, an integral part of constant force spring 16, and retained by spring boss 37, an integral part of spool 14. The constant force spring 16 is constrained on the wound end by means of spring tab 41, an integral part of constant force spring 16, retained in spring axle retainer slot 25 in spring axle 20, an integral part of left housing 2. Spool cover 23, positioned in cavity 46, constrains constant force spring 16 in the axial position on spool 14. Spring axle 20 is constrained by spring axle aperture 21, an integral part of right housing 3, alleviating lateral forces translated by constant force spring 16.

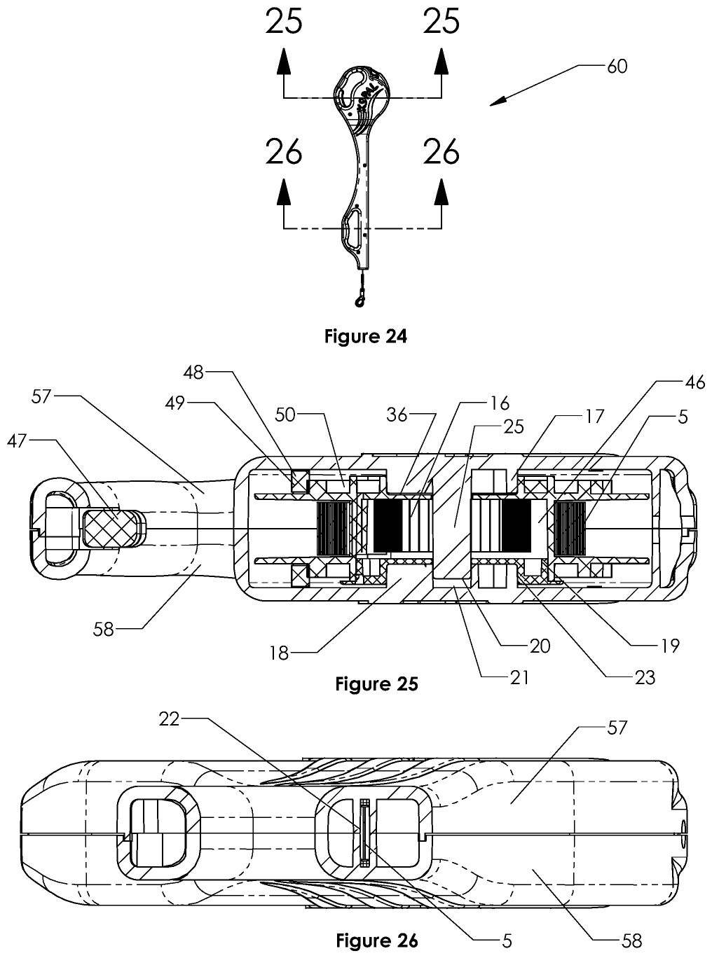

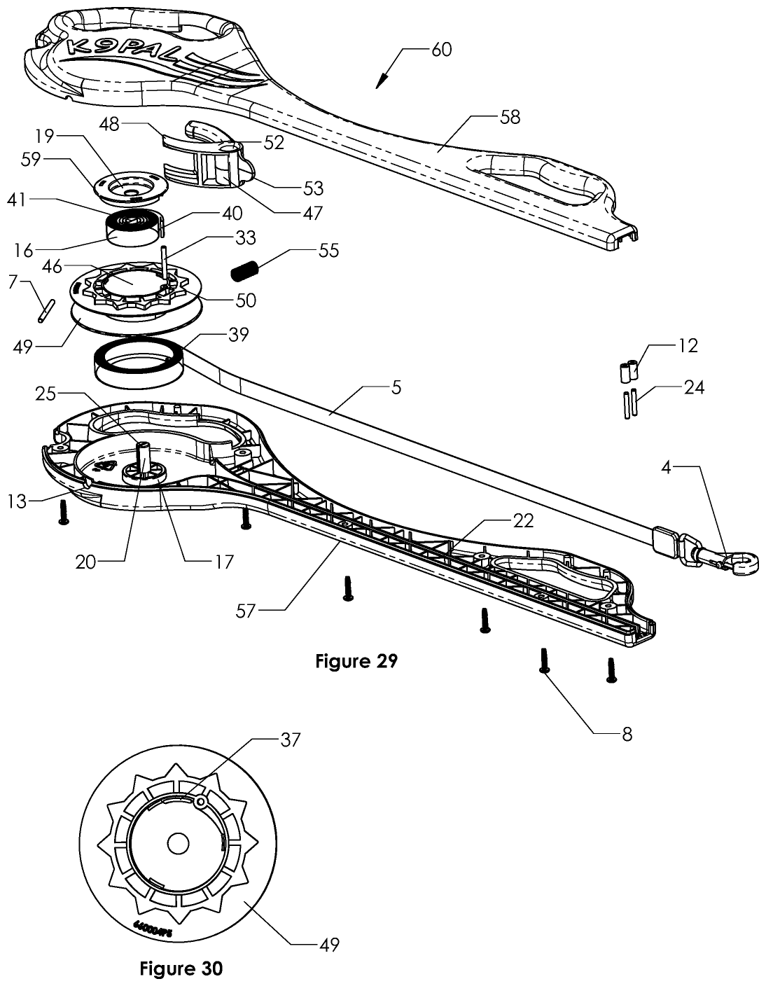

Referring to FIGS. 24, 25, 26, 27, 28, 29 and 30, on retractable dog leash assembly with drag lever 60, the leash retraction mechanism (collectively also referred to as the “drag assembly”) consists of the drag spool 49, constant force spring 16, spool cover 59, leash release lever 47, and lease release spring 55. The drag spool 49 is biased in the fully leash 5 retracted position by the constant force spring 16. As leash 5 is pulled by the swivel clip 4 in a distal direction, the constant force spring 16 is wound to bias the drag spool 49 in the opposite rotation to provide spring energy to rewind. This spring is constrained in cavity 46 on drag spool 49 by means of spring hook 40, an integral part of constant force spring 16, and retained by spring boss 37, an integral part of drag spool 49. The constant force spring 16 is constrained on the wound end by means of spring tab 41, an integral part of constant force spring 16, retained in spring axle retainer slot 25 in spring axle 20, an integral part of left drag housing 57. Spool drag cover 59, positioned in cavity 46, constrains constant force spring 16 in the axial position on drag spool 49. Spring axle 20 is constrained by spring axle aperture 21, an integral part of right drag housing 58, alleviating lateral forces translated by constant force spring 16.

On the two-handed retractable dog leash 1, spool 14 freely rotates inside the assembled left housing 2 and right housing 3 by means of left housing axle 17, an integral part of left housing 2, positioned into spool aperture 36 in spool 14. The other side of spool 4 is constrained by right housing axle 18, an integral part of right housing 3, positioned into spool cover aperture 19 in spool cover 23.

On the two-handed retractable dog leash assembly with drag lever 60, the leash assembly with drag lever 46, drag spool 49 freely rotates inside the assembled left drag housing 57 and right drag housing 58 by means of left housing axle 17, an integral part of left drag housing 57, positioned into spool aperture 36 in spool 49. The other side of drag spool 49 is constrained by right housing axle 18, an integral part of right drag housing 58, positioned into spool cover aperture 19 in drag spool cover 59.

On the two-handed retractable dog leash 1, leash 5 is retained on the proximal end to spool 14 by leash pin 33 sliding through spool 14 and leash loop 39 on leash 5. Leash 5 is guided through the assembly by leash slot 22, an integral part of left housing 2 and right housing 3. Leash 5 is prevented from chafing on the distal housing edges by rollers 12 retained by roller pins 24.

On the two-handed retractable dog leash assembly with drag lever 60, leash 5 is retained on the proximal end to drag spool 49 by leash pin 33 sliding through drag spool 49 and leash loop 39 on leash 5. Leash 5 is guided through the assembly by leash slot 22, an integral part of left drag housing 57 and right drag housing 58. Leash 5 is prevented from chafing on the distal housing edges by rollers 12 retained by roller pins 24.

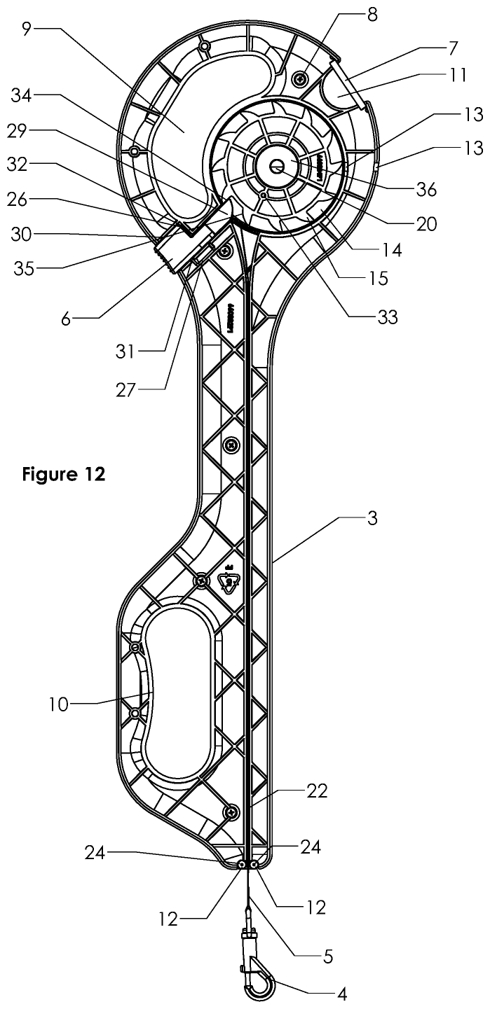

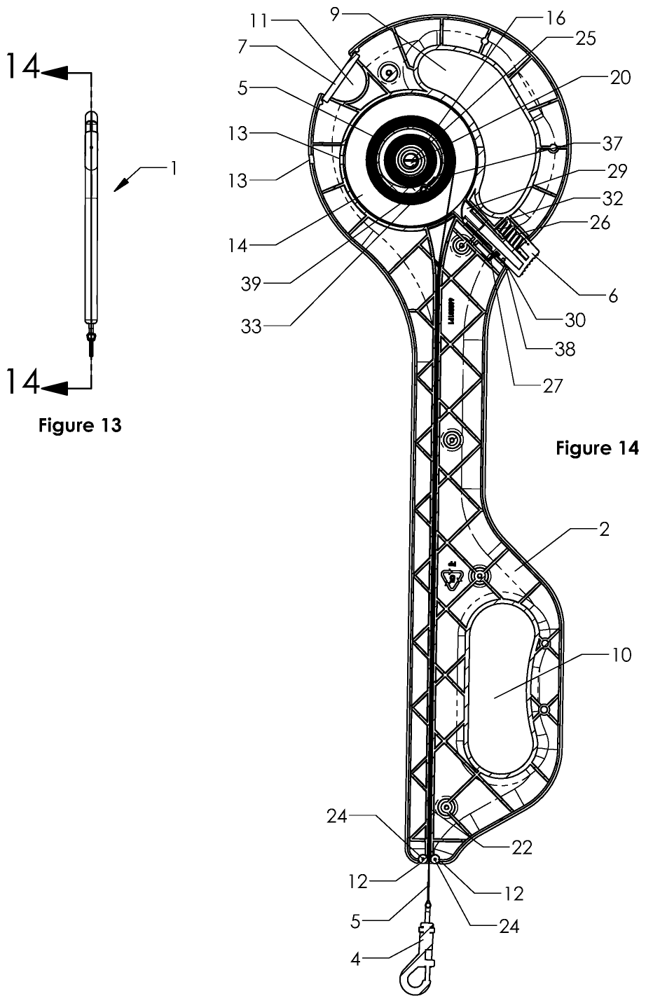

Referring to FIGS. 11, 12, 13, 14 and 15, on the two-handed retractable dog leash 1, the spool 14 can be locked, preventing rotation and thereby fixing the leash length, by the user. This is done by depressing stop actuator 6. Stop actuator 6 slides freely in stop actuator aperture 30 formed by the assembly of left housing 2 and right housing 3. Stop actuator 6 is biased to the distal position by stop actuator spring 26. Spring 26 pushes against rib 32 on the proximal end, an integral part of the housing assembly, and stop actuator 6 to provide this bias. When the stop actuator 6 is depressed by the user, stop actuator pawls 29, an integral part of stop actuator 6, slide into the path of a plurality of spool teeth 15 positioned around the circumference of the spool 14. Referring to FIG. 12, on the two-handed retractable dog leash 1, the actuator 6 is shown in the locked position. The actuator pawl 29 contacts tooth 15 on tooth flat surface 34 and tooth curved surface 35 to prevent rotation in either direction.

Referring to FIGS. 11 and 16, on the two-handed retractable dog leash 1, the stop actuator 6 is held in the locked and unlocked position by a push-push type mechanism comprised of a stop actuator keeper 27 retained in keeper retainer slot 28, as an integral part of left housing 2, a latch track 38, as an integral part of stop actuator 6, and a stop actuator spring 26. Stop actuator spring 26 biases stop actuator 6 to the most distal position, constrained only by stop actuator keeper 27. The keeper follower 31 on stop actuator keeper 27 follows and is constrained in latch track 38.

On the two-handed retractable dog leash 1, when stop actuator 6 is pushed, the keeper follower 31 is directed by the latch track 38 to latched over-travel position 43. When the stop actuator 6 is released, the keeper follower 31 is directed by the latch track 38 to the locked position detent 44. This is the locked position.

On the two-handed retractable dog leash 1, to unlock the spool 14, another press of the stop actuator 6, as directed by the latch track 38, drives the keeper follower 31 to unlatched over-travel position 45. When stop actuator 6 is released for the second time, the keeper follower 31 follows latch track 38 to released position detent 42. This is the released distal position of stop actuator 6.

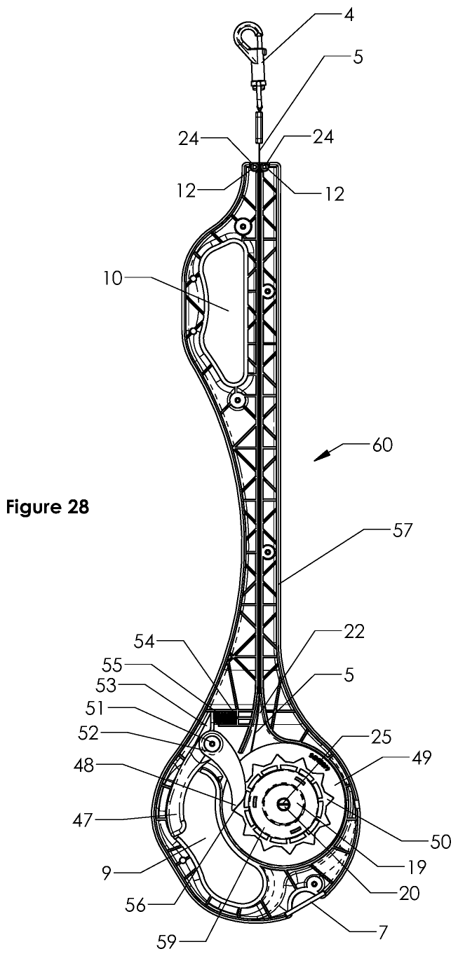

Referring to FIGS. 17, 18, 19, 20, 21, 22, 23, 24, 25, 26, 28, and 29, on the two-handed retractable dog leash assembly with drag lever 60, the drag spool 49 shown in the locked position in FIG. 28, preventing rotation and thereby fixing the leash length, by the user. This is done by allowing leash drag release lever 47 captured by drag lever aperture 52, as part of drag release lever 47, to rotate freely on lever boss 51 biased by leash release spring 55. Leash release spring 55 pushes against the spring bias boss 53, as part of the leash drag release lever 47, on the distal end and is held fixed in place by the spring retainer rib 54, as part of the left drag housing 57, on the proximal end. This allows the leash lever pawl 48, as part of the leash drag release lever 47, to contact one of a plurality of triangular spool teeth 50 as part of the drag spool 49, thereby preventing rotation of drag spool 49. If extreme pressure is exerted on leash 5, the friction interface 56 between the leash lever pawl 48 and triangular spool tooth 50 is overcome. This allows the drag spool 49 to slip and spin freely. This is a safety feature that allows the user to avoid the jolt of the inertia of a running dog as it is stopped by the end of the lease.

Referring to FIG. 27, the lease is shown in the unlocked position allowing leash 5 to give the dog maximum free leash. The unlocked position is accomplished by squeezing the leash drag release lever 47 to its full distal position, thereby overcoming spring bias and depressing the leash release spring 55, allowing the leash lever pawl 48 to rotate away from and disengage with the plurality of triangular spool teeth 50 on drag spool 49.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

### PARTS LIST

1 two-handed retractable dog leash
2 left housing
3 right housing
4 swivel clip
5 leash strap
6 stop actuator
7 accessory clip bar
8 screw
9 rear grip
10 forward grip
11 accessory clip aperture
12 roller
13 drain hole
14 spool
15 spool teeth
16 constant force spring
17 left housing axle
18 right housing axle
19 spool cover aperture
20 spring axle
21 spring axle aperture
22 leash slot
23 spool cover
24 roller pin
25 spring axle retainer slot
26 stop actuator spring
27 stop actuator keeper
28 keeper retainer slot
29 stop actuator pawl
30 stop actuator aperture
31 keeper follower
32 rib
33 leash pin
34 tooth flat surface
35 tooth curved surface
36 spool aperture
37 spring boss
38 latch track
39 leash loop
40 spring hook
41 spring tab
42 released position detent
43 latched over-travel position
44 locked position detent
45 unlatched over-travel position
46 spring cavity
47 leash drag release lever
48 leash lever pawl
49 drag spool
50 triangular spool tooth
51 lever boss
52 drag lever aperture
53 spring bias boss
54 spring retainer rib
55 leash release spring
56 friction interface
57 left drag housing
58 right drag housing
59 drag spool cover
60 leash assembly with drag

What is claimed is:

1. A two-handled retractable dog leash adapted for gripping with two hands comprising:
(a) an elongate housing comprising:
a first end terminating in a first handle integrally formed on the elongate housing and configured for gripping the dog leash,
(ii) a second end spaced apart from the first end of the elongate housing, the second end configured to feed and retract a dog leash through an opening positioned thereon, and
(iii) a second handle integrally formed on the elongate housing positioned between the first and second spaced apart ends of the elongate housing, the second handle configured for being gripped concurrently with the first handle to maintain control of a dog;
(b) a rotatable, retractable spool positioned inside the elongate housing proximate to the first handle; and
(c) a retractable leash wrapped around and carried on the spool, the retractable leash configured to move on the spool and selectively adjust in length being fed through the opening positioned on the second end the elongate handle.

2. The two-handled retractable dog leash of claim 1, further comprising an axle internally positioned axle that carries the rotatable, retractable spool thereon.

3. The two two-handled retractable dog leash of claim 2, further comprising a locking mechanism in operable contact with the rotatable, retractable spool configured to lock the spool thereby preventing length adjustment of the leash.

4. The two two-handled retractable dog leash of claim 3, further comprising a plurality of spaced apart fasteners positioned along the length of the elongate housing configured to secure and maintain the elongate housing as a unitary component.

5. The two two-handled retractable dog leash of claim 4, wherein the elongate housing comprises a rigid or a semi-rigid material.

6. The two two-handled retractable dog leash of claim 4, wherein the rigid or semi-rigid material is a moldable thermoplastic resin or a millable resin.

7. The two-handled retractable dog leash of claim 4, further comprising a drag assembly positioned internally within the retractable dog least that is configured to selectively reduce and/or limit leash movement and feed speed through the opening positioned on the second end of the elongate handle.

8. The two-handled retractable dog leash of claim 7, further comprising a drag assembly lever that is externally positioned on the first handle of the two-handled retractable dog leash and is operatively connected to the drag assembly such that drag assembly reduces and/or limits leash movement through the opening positioned on the second end of the elongate handle when the drag assembly lever is actuated.

9. The two-handled retractable dog leash of claim 8, wherein the drag assembly is unidirectionally operable to selectively reduce and/or limit leash movement and feed speed one way when the leash is fed through the opening positioned on the second end of the elongate handle to extend length of the leash outside of the housing of the two-handled retractable dog leash but does not selectively reduce and/or limit leash movement when retracting the leash through the second end of the elongate handle and rewinding the leash onto the spool.

10. The two-handled retractable dog leash of claim 9, wherein the drag assembly lever is positioned on an underside of the first handle of the two-handled retractable dog leash.

11. The two-handled retractable dog leash of claim 10, wherein the drag assembly lever is positioned on an underside of the first handle of the two-handled retractable dog leash.

12. The two-handled retractable dog leash of claim 8, wherein the drag assembly lever is positioned on an underside of the first handle of the two-handled retractable dog leash.

13. The two-handled retractable dog leash of claim 1, further comprising a drag assembly positioned internally within the retractable dog least that is configured to selectively reduce and/or limit leash movement and feed speed through the opening positioned on the second end of the elongate handle.

14. The two-handled retractable dog leash of claim 13, further comprising a drag assembly lever that is externally positioned on the first handle of the two-handled retractable dog leash and is operatively connected to the drag assembly such that drag assembly reduces and/or limits leash movement through the opening positioned on the second end of the elongate handle when the drag assembly lever is actuated.

15. The two-handled retractable dog leash of claim 14, wherein the drag assembly is unidirectionally operable to selectively reduce and/or limit leash movement and feed speed one way when the leash is fed through the opening positioned on the second end of the elongate handle to extend length of the leash outside of the housing of the two-handled retractable dog leash but does not selectively reduce and/or limit leash movement when retracting the leash through the second end of the elongate handle and rewinding the leash onto the spool.

16. The two-handled retractable dog leash of claim 15, wherein the drag assembly lever is positioned on an underside of the first handle of the two-handled retractable dog leash.

17. The two-handled retractable dog leash of claim 16, wherein the drag assembly lever is positioned on an underside of the first handle of the two-handled retractable dog leash.

18. The two-handled retractable dog leash of claim 14, wherein the drag assembly lever is positioned on an underside of the first handle of the two-handled retractable dog leash.
